(19) United States
(12) Patent Application Publication
(10) Pub. No.: US 2008/0315566 A1
(43) Pub. Date: Dec. 25, 2008

(54) INSTRUMENT PANEL WITH INTEGRAL HIDDEN DOOR COVER AND METHOD OF MANUFACTURE THEREOF

(76) Inventors: Joseph Andrasik, III, Union, OH (US); Steven L. Snead, Miamisburg, OH (US)

Correspondence Address: CANTOR COLBURN, LLP, 20 Church Street, 22nd Floor, Hartford, CT, 06103, US

(21) Appl. No.: 11/766,084

(22) Filed: Jun. 20, 2007

(51) Int. Cl. B60R 21/215

(52) U.S. Cl. 280/728.3

(57) ABSTRACT

A cover for an airbag module, comprising: an outer layer having a show surface and an inner surface; a molded tear seam in the inner surface, the molded tear seam defining a deployment door opening in the cover, the molded tear seam extending into the cover from the inner surface, wherein the molded tear seam does not extend through to the outer layer and is not visible through the show surface; and a score provided in the molded tear seam, the score extending from the molded tear seam towards the show surface, a portion of the score being closer to the show surface than the molded tear seam, wherein the score is formed in the molded tear seam after the molded tear seam has been formed.

### BACKGROUND

The present invention relates generally to an instrument panel used in a vehicle having an inflatable cushion or airbag module, and more particularly to an instrument panel cover having an integral hidden door and the method of manufacture thereof.

Vehicles are now equipped with some type of inflatable cushions or airbag modules and other vehicle components have been modified to accommodate the use of such systems. For example, most passenger side airbag modules are disposed within and behind an instrument panel which extends across at least a portion of the width of a vehicle compartment. During assembly and/or manufacture, an instrument panel in a vehicle having a passenger side airbag module requires a discrete door which covers an opening formed in the instrument panel for the inflatable cushion to deploy through upon actuation of the airbag module. This separate door is designed to open in response to the force of the expanding inflatable cushion. In other words as the pressure in the inflatable cushion increases, the volume of the cushion increases and applies a force to a portion of the door wherein the door selectively separates from the remaining portion of the instrument panel to permit the inflatable cushion to deploy therethrough.

Typically, the manufacture of the instrument panel involves forming an opening in the instrument panel adjacent to the location of the airbag module. The opening is then covered by a separate door which is secured to the instrument panel and faces the occupants of the vehicle. Thus, the instrument panel itself is manufactured in view of the shape and size of the door and the door is separately manufactured and installed in the instrument panel using known techniques. However, the outer periphery of such a door is clearly visible to the vehicle occupant and may create an unpleasing appearance to the instrument panel.

Due to ongoing desires for improving the aesthetics of the passenger compartment, it is desirable to provide aesthetically pleasing, functional alternatives to the conventional instrument panels having a separate door covering the airbag module.

### SUMMARY OF THE INVENTION

According to an exemplary embodiment of the present invention, a cover for use with an airbag module is provided. The cover having a hidden deployment region or deployable door integral with the cover is also provided. In accordance with exemplary embodiments of the present invention, the cover may be used as an instrument panel or a cover for a driver's side airbag module. More specifically, a cover for use with an airbag module and method of making is disclosed.

In one exemplary embodiment the cover is an instrument panel or a portion thereof. In another exemplary embodiment the cover is configured for use with a driver's side airbag module. In accordance with an exemplary embodiment the cover is configured to have a hidden airbag module door opening. The cover comprising: an outer layer having a show surface and an inner surface; a molded tear seam in the inner surface, the molded tear seam defining a deployment door opening in the cover, the molded tear seam extending into the cover from the inner surface, wherein the molded tear seam does not extend through to the outer layer and is not visible through the show surface; and a score provided in the molded tear seam, the score extending from the molded tear seam towards the show surface, a portion of the score being closer to the show surface than the molded tear seam, wherein the score is formed in the molded tear seam after the molded tear seam has been formed.

In another exemplary embodiment a method of forming the hidden, integral airbag door in the cover is provided, the method comprising: molding a first layer with an injection molding process, the first layer having a show surface and an inner surface, wherein a molded tear seam is formed in the inner surface, the molded tear seam defining a deployment door opening in the first layer, the molded tear seam extending into the inner surface, wherein the molded tear seam does not extend through the first layer to the show surface, and is not visible through the show surface; and scoring the inner surface with a scoring device to define a scoring pattern in the molded tear seam, the scoring pattern extending from the molded tear seam towards the show surface, wherein the scoring pattern is formed in the molded tear seam after the molded tear seam has been formed.

### BRIEF DESCRIPTION OF THE DRAWINGS

The present invention will now be described, by way of example only, with reference to the accompanying drawings in which:

FIG. 1 is a partial cross sectional view of a vehicle interior;

FIG. 2 is a partial perspective view of a vehicle interior;

FIG. 3 is a view along lines 3-3 of FIG. 2; and

FIG. 4 is a flow chart illustrating a method of forming an instrument panel or cover in accordance with an exemplary embodiment of the present invention.

The above-described and other features and advantages of the present application will be appreciated and understood by those skilled in the art from the following detailed description, drawings, and appended claims.

### DETAILED DESCRIPTION OF EXEMPLARY EMBODIMENTS

In accordance with exemplary embodiments of the present invention an airbag module cover with a deployable door and invisible tear seam is provided. The deployable door is formed in the cover via a two step process wherein the cover is first formed during a molding process (e.g., injection molding or slush molding or other equivalent process) wherein the mold cavity is configured to have features to define a tear seam in one side of the airbag module cover. Then after the molding process an ultrasonic cutting device is used to provide a score in the tear seam. In accordance with exemplary embodiments of the present invention, the tear seam and the score are formed on an inner surface of the cover wherein the tear seam and the score is not visually viewable from the outer or show surface of the cover. Non-limiting applications of the cover comprising the deployable door are used as an instrument panel in a vehicle or a cover for a driver side airbag module. Other contemplated uses may be a cover for a side airbag module located in a vehicle door or body panel.

In accordance with an exemplary embodiment, the cover will provide a means for covering a portion of an airbag module, wherein an inflatable cushion is positioned to deploy through the deployable door defined by the tear seams of the cover. In accordance with an exemplary embodiment, the inflating cushion will cause the deployable door to pivot open while tearing along the tear seams positioned in a portion of cover in order to provide an opening for the inflatable cushion to deploy therethrough while a portion of the deployable door is still pivotally secured to the cover.

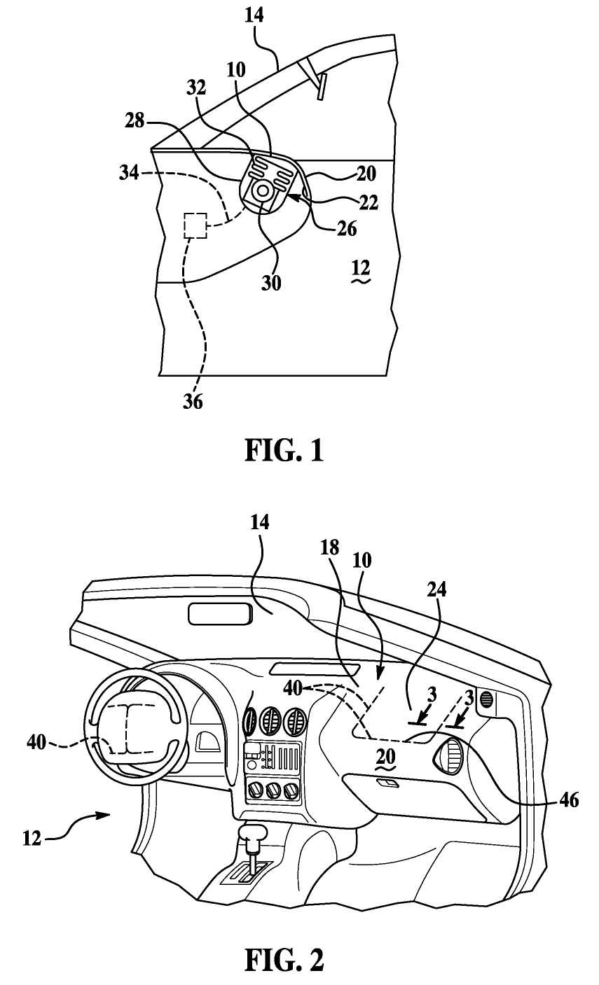

Referring now to FIGS. 1-2, exemplary embodiments of the present invention are illustrated. In FIGS. 1-2 an instrument panel is generally indicated at 10. The instrument panel 10 is assembled into a vehicle passenger compartment 12 partially shown in FIG. 2. The instrument panel is generally disposed beneath a windshield 14 and extends across substantially the entire width of the passenger compartment 12.

In accordance with exemplary embodiments of the present invention and as will be described in greater detail hereinafter, the instrument panel comprises a cover 18 having an outer show surface 20 and an inner surface 22. In one embodiment, the instrument panel further comprises a deployment door 24 formed therein. The deployment door is intended to be in the general area corresponding to a passenger side airbag module 26. Accordingly, the passenger side airbag module is located and deployed therethrough during actuation of the passenger side airbag module under predetermined deployment conditions.

Airbag module 26 further comprises a housing 28, an inflator 30 and an inflatable cushion 32 wherein the inflator inflates the inflatable cushion in response to a signal 34 received from a sensing or control module 36 configured to determine if an activation event is occurring. As is known in the related arts, the control module receives signals from a plurality of sensors disposed throughout the vehicle.

In accordance with an exemplary embodiment, the instrument panel is formed via an injection molding process using any number of suitable materials. In one exemplary embodiment, the instrument panel is formed from thermoplastic materials. For example, suitable thermoplastic materials include but are not limited to polyethylene based polyolefin elastomer or polypropylene based thermoplastic elastomer, poly-urethane resins and other co-polymers and equivalents thereof. Non-limiting examples include; thermoplastic elastic olefin (TEO), thermoplastic elastomer (TPE), thermoplastic elastomer-oefinic (TPE-O, TPO), thermoplastic elastomer-styrenic (TPE-S), Polycarbonate (PC), Polycarbonate/Acrylonitrile-Butadiene-Styrene (PC/ABS), Acrylonitrile-Butadiene-Styrene (ABS) copolymers, Poly-urethane (TPU) and Polyvinyl-Chloride (PVC).

Preferred materials are those materials that have the desired characteristics of strength, durability, flexibility, and finished appearance and feel for use as an instrument panel 10 cover therefore or a cover for a driver's side airbag module. As illustrated, the instrument panel is mounted within the vehicle so that an outer surface is visible to a vehicle occupant and an inner surface forms a contact surface for the inflatable cushion. In accordance with an exemplary embodiment cover 18 is a single layer and the inner surface is disposed proximate to the inflatable cushion. This is in contrast to other designs wherein the instrument panel comprises a plurality of layers such as an outer surface, inner foamed layer and lower substrate layer each separately formed and then adhered together.

It is, of course, understood that the passenger side airbag module and the configuration of the instrument panel illustrated in FIGS. 1 and 2 are provided as examples and various other configurations of the instrument panel and the airbag module are contemplated thus, the present invention is not intended to be limited to the specific configurations illustrated in FIGS. 1 and 2.

In accordance with an exemplary embodiment of the present invention the outer layer of the instrument panel comprises an interior show surface of the instrument panel. As described herein, the shown surface is intended to include the surface of the instrument panel that is exposed to the vehicle interior and its occupants.

Thus, a sheet of material having a show surface or an outer aesthetically pleasing appearance is provided. In accordance with an exemplary embodiment the same sheet or instrument panel provides a cover for an airbag module. In accordance with an exemplary embodiment and referring now to FIGS. 1-3, the sheet of material comprising the instrument panel and/or cover of the airbag module is formed with a molded in tear seam 40. The cover has a layer 42 having show surface 20 and an inner surface 44. The cover is configured to have the molded tear seam in the inner surface of the cover. In addition, the inner surface is configured to make contact with the deploying inflatable cushion. The molded tear seam defines a deployment door opening 46 in the cover.

In accordance with an exemplary embodiment, the cover may be configured for use with a driver's side steering wheel application or a passenger side airbag module. In other words the cover may be configured to be secured to the driver's side airbag module or comprise the instrument panel of a vehicle or a portion thereof.

In accordance with an exemplary embodiment, the molded tear seam extends into the cover from the inner surface, wherein the molded tear seam does not extend through to the outer layer leaving a thickness 45. Thus, and when the cover is installed in the vehicle the tear seam is not visible through the show surface. In accordance with an exemplary embodiment thickness 45 is large enough to provide a sufficient amount of strength to the cover however, thickness 45 is also large enough to cause the cover to tear or break in a manner that may cause fragmentation during deployment of the inflatable cushion of the airbag module. In other words, thickness 45 while providing an invisible tear seam of a cover of an airbag module does not break or tear efficiently during deployment of the airbag module thus, thickness 45 is larger than a desirable thickness of a deployable tear seam.

In accordance with an exemplary embodiment of the present invention and when the cover is formed from a TPO (e.g., Thermal Plastic Olefin, Thermo-Plastic Polyolefin, Thermoplastic Olefin, etc.) resin, thickness 45 is within the range of 1.0 to 3.0 millimeters (mm). Of course thickness 45 may be greater or less than the aforementioned range. In addition, thickness 45 may vary based upon the type of material(s) used for the cover including among others non-TPO resins. In accordance with an exemplary embodiment and after the cover is formed using the molding process, a score 46 is provided in the molded tear seam. The score is provided in the molded tear seam after the same is formed by a molding process wherein suitable thermoplastic material is injected under pressure into a pre-heated mold and then cooled or in a slush-cast molding process where polyolefin or poly-urethane resins are either sprayed as a liquid or inserted as a powder into a heated mold and subsequently cooled. Thus, the score is cut into the cover after the cover is formed.

In accordance with an exemplary embodiment, score 46 extends from the molded tear seam towards the show surface, wherein a portion of the score is closer to the show surface than any portion of the molded tear seam leaving a thickness 47, which is smaller than thickness 45.

In accordance with an exemplary embodiment thickness 47 is large enough to conceal the score from the show surface however, thickness 47 is also thin enough to cause the cover to tear or break in an efficient manner that prevents fragmentation of the cover along the tear seam during deployment of the inflatable cushion of the airbag module. In other words, thickness 47 while providing an invisible tear seam of a cover of an airbag module tears efficiently during deployment of the airbag module.

In accordance with an exemplary embodiment of the present invention and when the cover is formed from a TPO resin thickness 47 is within the range of 0.3 to 0.5 millimeters (mm). Of course thickness 47 may be greater or less than the aforementioned range. In addition, thickness 47 may vary based upon the type of material(s) used for the cover.

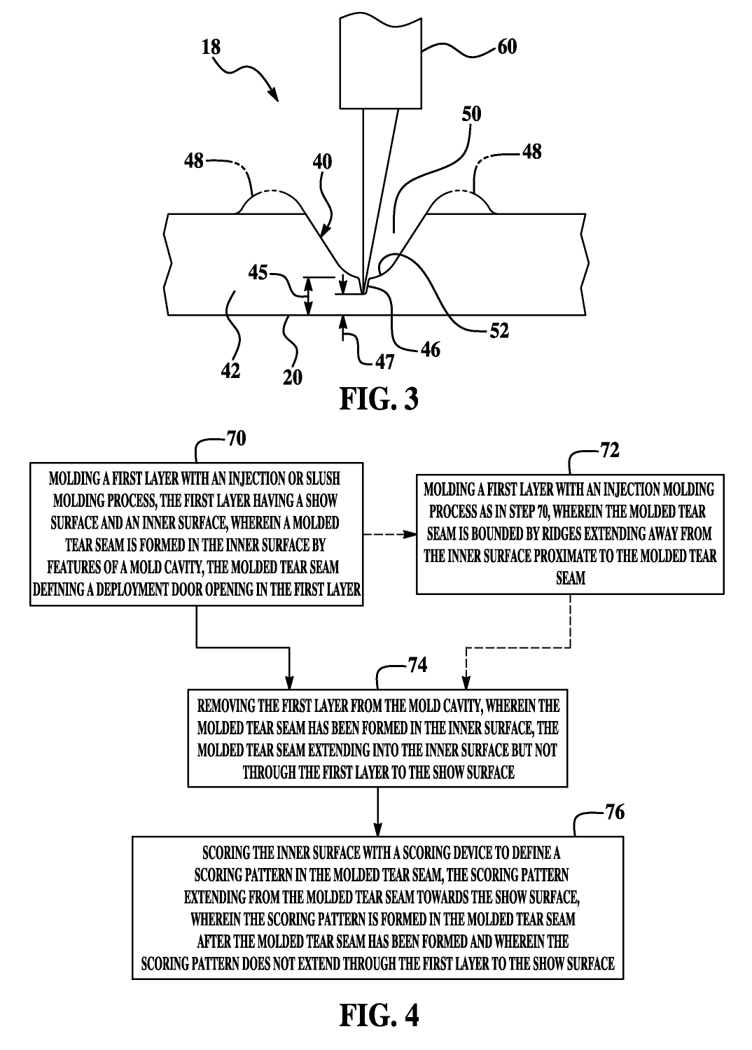

In addition and in accordance with an exemplary embodiment of the present invention the width of score 46 is much smaller than the width of the molded in tear seam 40 thus, score 46 is invisible from the outer show surface of the cover. Additionally, the overall depth and size of score 46 is much smaller than that of molded in tear seam 40. In other words and as illustrated in FIG. 3, score 46 is substantially smaller in width and depth as compared to molded in tear seam 40.

In accordance with an exemplary embodiment, the cover does not comprise any other layers thus, the show surface and the deployment door, deployment door pattern, molded in tear seam and score are all formed in the same layer, which is formed using an injection molding process or slush molding process.

In accordance with an alternative exemplary embodiment, the outer layer and the molded tear seam is configured to define a “U” or “V” shaped groove with a ridge portion 48 located on either side of the groove, each ridge portion being configured to extend away from the inner surface. In yet another alternative exemplary embodiment, the “U” shaped groove defines a valley 50 having a surface 52 located at a bottom portion of the molded tear seam, wherein the score is located in the surface of the valley. It is, of course, understood that the groove is not limited to “V” or “U” shapes and that the groove may have any other shape.

In accordance with an exemplary embodiment the cover is formed by an injection molding process, wherein the tool is configured to define the tear seam and alternatively the ridges that extend from either side of the tear seam. Non-limiting examples of the materials contemplated for the cover include a thermoplastic elastomer, thermoplastic olefin and other copolymers and poly-urethane resins and equivalents thereof.

Thereafter a scoring device 60 with a knife or cutting portion 62 is provided to provide score 46.

In accordance with an exemplary embodiment, a method of forming a hidden, integral airbag door is provided. First the cover is formed by an injection molding process, wherein the cover is configured to have a show surface, an inner surface, and a molded tear seam is the inner surface. The molded in tear seam defining a deployment door opening in the cover. The molded in tear seam extends into the inner surface but does not extend through the cover thus, the molded in tear seam is not visible from the show surface. The cover has a thickness remaining between the show surface and the valley of the tear seam, which in order to provide adequate tearing of the cover must be further manipulated to provide adequate tearing of the cover.

Thereafter and in order to provide adequate tearing of the cover, the inner surface of the cover is scored with a scoring device to define a scoring pattern in the molded tear seam, the scoring pattern extending from the molded tear seam towards the show surface. In accordance with an exemplary embodiment the scoring pattern is formed in the molded tear seam after the molded tear seam has been formed. The score will assist in the tearing of the cover during deployment of the inflatable cushion. In addition, the score and the molded in tear seam will not be visible from the shown surface of the cover.

In accordance with an exemplary embodiment the score or scores are provided by introducing a cutting means such as a cutting knife or an oscillating cutting knife, wherein the knife is either heated or not, or a laser scoring device and equivalents thereof. The cutting means will score the inner surface without extending all the way through layer thus, the deployment opening of the cover or instrument panel will not be visually perceivable from the show surface of the outer layer. In accordance with an exemplary embodiment, cuts or scores will define a “U” shaped pattern corresponding to the molded tear seam to define three separable or tearing edges and a fourth non-tearing edge that is aligned with a hinge portion of the deployable door. Of course, other non-limiting configurations are possible (e.g., an “I” or “H” shaped tear seam opening).

The deployment region of the cover is formed in the instrument panel so that the inflatable cushion is orientated in front of a passenger seated in the passenger compartment. The instrument panel and more specifically the deployment region, is used to conceal the inflatable cushion in an aesthetically pleasing manner. The deployment region is formed in the instrument panel with the appropriate alignment of the deployment region with the passenger side airbag module so that upon deployment of the inflating cushion the same is forced through the instrument panel at its weakest point. In other words, the inflatable cushion exerts pressure on the inner surface of the instrument panel and causes the deployable door to separate along the scores and cuts formed therein. The deployment region is sized and shaped so that the passenger side air bag cushion successfully deploys therethrough upon actuation. Accordingly, the size of the deployment region is dependent upon the size and shape of the inflatable cushion. Similarly and when the cover is configured for use as a driver's side airbag module cover the same is configured to cover the inflatable cushion typically centered on the steering wheel.

As shown in FIGS. 1-3, the molded tear seam and score 46 matches the patterns shown in FIG. 2. Of course, numerous other patterns are contemplated for exemplary embodiments of the present invention.

One non-limiting example of an apparatus for injection molding an instrument panel in accordance with an exemplary embodiment of the present invention comprises a first die or tool configured to have a cavity for defining portions of the instrument panel or driver's side airbag module cover. In addition, the tool will also have a feature for defining the molded tear seam. A second tool or die having complimentary features is applied to the first tool in order to from the instrument panel or cover in accordance with known injection molding techniques.

Another non-limiting method for forming the instrument panel comprises a slush cast molding process wherein polyolefin or poly-urethane resins are either sprayed as a liquid or inserted as a powder into a heated mold and the tear seam is molded there in by a tool being inserted into the mold or by features integral with the mold and thereafter the formed article is subsequently cooled.

FIG. 4 depicts a flow chart illustrating methods of forming an instrument panel or cover with an integral hidden door cover. In accordance with an exemplary embodiment step 70 provides that a first layer is molded with an injection or slush molding process, the first layer having a show surface and an inner surface, wherein a molded tear seam is formed in the inner surface by features of a mold cavity, the molded tear seam defining a deployment door opening in the first layer.

At step 74, the first layer was removed from the mold cavity, wherein the molded tear seam has been formed in the inner surface, the molded tear seam extending into the inner surface but not through the first layer to the show surface. The molded tear seam leaving a thickness 45 in the cover. In accordance with an exemplary embodiment thickness 45 is large enough to provide a sufficient amount of strength to the cover however, thickness 45 is also large enough to cause the cover to tear or break in a manner that may cause fragmentation during deployment of the inflatable cushion of the airbag module. In other words, thickness 45 while providing an invisible tear seam of a cover of an airbag module does not break or tear efficiently during deployment of the airbag module thus, thickness 45 is larger than a desirable thickness of a deployable tear seam.

At step 76 the inner surface is scored with a scoring device to define a scoring pattern in the molded tear seam, the scoring pattern extending from the molded tear seam towards the show surface, wherein the scoring pattern is formed in the molded tear seam after the molded tear seam has been formed and wherein the scoring pattern does not extend through the first layer to the show surface.

In accordance with an exemplary embodiment, score 46 extends from the molded tear seam towards the show surface, wherein a portion of the score is closer to the show surface than any portion of the molded tear seam leaving a thickness 47 between the outer show surface and the bottom of the score, wherein thickness 47 is smaller than thickness 45.

In accordance with an exemplary embodiment thickness 47 is large enough to conceal the score from the show surface however, thickness 47 is also thin enough to cause the cover to tear or break in an efficient manner that prevents fragmentation of the cover along the tear seam during deployment of the inflatable cushion of the airbag module. In other words, thickness 47 while providing an invisible tear seam of a cover of an airbag module tears efficiently during deployment of the airbag module. Furthermore, score 46 is much smaller in depth and width than molded tear seam 40.

Accordingly, steps 70, 74 and 76 illustrate an exemplary embodiment of the present invention. In accordance with an alternative exemplary embodiment and at step 72 the first layer is molded with by the injection molding process as in step 70, wherein the molded tear seam is bounded by ridges extending away from the inner surface proximate to the molded tear seam. Thereafter, steps 74 and 76 are repeated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A cover for an airbag module, comprising:
an outer layer having a show surface and an inner surface;
a molded tear seam in the inner surface, the molded tear seam defining a deployment door opening in the cover, the molded tear seam extending into the cover from the inner surface, wherein the molded tear seam does not extend through to the outer layer and is not visible through the show surface, the molded tear seam leaving a first thickness of the cover between the show surface and the molded tear seam; and
a score provided in the molded tear seam, the score extending from the molded tear seam towards the show surface, a portion of the score being closer to the show surface than the molded tear seam leaving a second thickness of the cover between the show surface and the score, the second thickness being less than the first thickness, wherein the score is formed in the molded tear seam after the molded tear seam has been formed.

2. The cover as in claim 1, wherein the cover is an instrument panel configured for use in a vehicle.

3. The cover as in claim 2, wherein the cover does not comprise any other layers.

4. The cover as in claim 1, wherein the cover is configured to cover a driver side airbag module and the cover does not comprise any other layers.

5. The cover as in claim 1, wherein the molded tear seam defines a “U” shaped groove with a ridge located on either side of the groove, each ridge extending away from the inner surface.

6. The cover as in claim 5, wherein the cover is configured to cover a driver side airbag module and the cover does not comprise any other layers.

7. The cover as in claim 5, wherein the “U” shaped groove defines a valley having a surface located at a bottom portion of the molded tear seam, wherein the score is located in the valley and the cover does not comprise any other layers.

8. The cover as in claim 1, wherein the molded tear seam defines a “V” shaped groove with a ridge located on either side of the groove, each ridge extending away from the inner surface.

9. The cover as in claim 8, wherein the “V” shaped groove defines a valley having a surface located at a bottom portion of the molded tear seam, wherein the score is located in the valley.

10. The cover as in claim 9, wherein the cover does not comprise any other layers and the cover is an instrument panel configured for use in a vehicle and the cover is formed by an injection molding process.

11. The cover as in claim 10, wherein the cover is formed from a thermoplastic elastomer.

12. The cover as in claim 1, wherein the cover is formed by an injection molding process.

13. A method of forming a hidden, integral airbag door, the method comprising:
molding a first layer with an injection molding process, the first layer having a show surface and an inner surface, wherein a molded tear seam is formed in the inner surface, the molded tear seam defining a deployment door opening in the first layer, the molded tear seam extending into the inner surface, wherein the molded tear seam does not extend through the first layer to the show surface and is not visible through the show surface, the molded tear seam leaving a first thickness of the cover between the show surface and the molded tear seam; and
scoring the inner surface with a scoring device to define a scoring pattern in the molded tear seam, the scoring pattern extending from the molded tear seam towards the show surface the scoring pattern leaving a second thickness of the cover between the show surface and the score, the second thickness being less than the first thickness, wherein the scoring pattern is formed in the molded tear seam after the molded tear seam has been formed.

14. The method as in claim 13, wherein the first layer is an instrument panel configured for use in a vehicle and the instrument panel does not comprise any other layers.

15. The method as in claim 13, wherein the first layer is a driver's side airbag module cover, which does not comprise any other layers.

16. The method as in claim 13, wherein the molded tear seam defines a “U” shaped groove with a ridge located on either side of the groove, each ridge extending away from the inner surface and the “U” shaped groove defines a valley having a surface located at a bottom portion of the molded tear seam, wherein the scoring pattern is located in the valley.

17. The method as in claim 16, wherein the first layer is a driver's side airbag module cover or an instrument panel configured for use in a vehicle, which does not comprise any other layers.

18. The method as in claim 16, wherein the first layer is formed from a thermoplastic elastomer or a thermoplastic olefin.

19. The method as in claim 13, wherein the scoring step is performed by any one of the following: a hot knife, an ultrasonic knife or a laser scribe.
